(19) United States
(12) Patent Application Publication
(10) Pub. No.: US 2026/0197875 A1
(43) Pub. Date: Jul. 9, 2026

(54) FLEXIBLE PHYSICAL RANDOM ACCESS CHANNEL OPERATION

(71) Applicant: Nokia Technologies Oy, Espoo (FI)

(72) Inventors: Jie GAO, Zhejiang (CN); Elena PERALTA CALVO, Tampere (FI); Alessio MARCONE, Munich (DE); Nhat-Quang NHAN, Reims (FR)

(21) Appl. No.: 19/125,779

(22) PCT Filed: Nov. 4, 2022
(86) PCT No.: PCT/CN2022/130089

§ 371 Date: Apr. 30, 2025

(51) Int. Cl. H04W 74/0833

(52) U.S. Cl. CPC H04W 74/0833

(57) ABSTRACT

Example embodiments of the present disclosure relate to a terminal device, a network device, methods, apparatuses and a computer readable storage medium for flexible PRACH operation. A terminal device may receive RACH configuration information indicating at least two PRACH configuration indexes. The terminal device may select one from the at least two PRACH configuration indexes and transmit a preamble based on the selected PRACH configuration index. As such, the terminal device can efficiently choose a proper PRACH configuration index and accordingly transmit a proper preamble. Therefore, the access delay can be reduced, the power consumption can be reduced, and the efficiency of access can be improved.

### FIELD

Example embodiments of the present disclosure generally relate to the field of telecommunication and in particular, to a terminal device, a network device, methods, apparatuses and a computer readable storage medium for a solution of flexible physical random access channel (PRACH) operation.

### BACKGROUND

A network device may configure a PRACH preamble for the user equipment (UEs) in the cell. In case the preamble is short, a UE far from the network device may not successfully access due to the poor coverage. In case the preamble is long, a UE near the network device may suffer large delay and the collision probability may be increased. It is impossible for all UEs in the cell to efficiently initial access no matter the preamble is long or short, in this regard, the PRACH operation needs to be studied further.

### SUMMARY

In general, example embodiments of the present disclosure provide a solution for flexible PRACH operation.

In a first aspect, there is provided a terminal device. The terminal device comprises at least one processor and at least one memory storing instructions that, when executed by the at least one processor, cause the terminal device at least to: receive, from a network device, random access channel (RACH) configuration information indicating at least two physical random access channel (PRACH) configuration indexes; select one PRACH configuration index from the at least two PRACH configuration indexes; and transmit, to the network device, a RACH preamble based on the selected PRACH configuration index.

In a second aspect, there is provided a network device. The network device comprises at least one processor and at least one memory storing instructions that, when executed by the at least one processor, cause the network device at least to: transmit, to a terminal device, random access channel (RACH) configuration information indicating at least two physical random access channel (PRACH) configuration indexes; and receive, from the terminal device, a PRACH preamble associated with one of the at least two PRACH configuration indexes.

In a third aspect, there is provided a method performed by a terminal device. The method comprises: receiving, at a terminal device from a network device, random access channel (RACH) configuration information indicating at least two physical random access channel (PRACH) configuration indexes; selecting one PRACH configuration index from the at least two PRACH configuration indexes; and transmitting, to the network device, a RACH preamble based on the selected PRACH configuration index.

In a fourth aspect, there is provided a method performed by a network device. The method comprises: transmitting, at a network device to a terminal device, random access channel (RACH) configuration information indicating at least two physical random access channel (PRACH) configuration indexes; and receiving, from the terminal device, a PRACH preamble associated with one of the at least two PRACH configuration indexes.

In a fifth aspect, there is provided an apparatus. The apparatus comprises: means for receiving, at a terminal device from a network device, random access channel (RACH) configuration information indicating at least two physical random access channel (PRACH) configuration indexes; means for selecting one PRACH configuration index from the at least two PRACH configuration indexes; and means for transmitting, to the network device, a RACH preamble based on the selected PRACH configuration index.

In a sixth aspect, there is provided an apparatus. The apparatus comprises: means for transmitting, at a network device to a terminal device, random access channel (RACH) configuration information indicating at least two physical random access channel (PRACH) configuration indexes; and means for receiving, from the terminal device, a PRACH preamble associated with one of the at least two PRACH configuration indexes.

In a seventh aspect, there is provided a non-transitory computer readable medium comprising program instructions for causing an apparatus to perform at least the method in the third or fourth aspect.

In an eighth aspect, there is provided a computer program comprising instructions, which, when executed by an apparatus, cause the apparatus at least to perform the method in the third or fourth aspect.

In a ninth aspect, there is provided a terminal device. The terminal device comprises: receiving circuitry configured to receive, from a network device, random access channel (RACH) configuration information indicating at least two physical random access channel (PRACH) configuration indexes; selecting circuitry configured to select one PRACH configuration index from the at least two PRACH configuration indexes; and transmitting circuitry configured to transmit, to the network device, a RACH preamble based on the selected PRACH configuration index.

In a tenth aspect, there is provided a network device. The network device comprises: transmitting circuitry configured to transmit, to a terminal device, random access channel (RACH) configuration information indicating at least two physical random access channel (PRACH) configuration indexes; and receiving circuitry configured to receive, from the terminal device, a PRACH preamble associated with one of the at least two PRACH configuration indexes.

In an eleventh aspect, there is provided a computer readable medium comprising program instructions that, when executed by an apparatus, cause the apparatus to perform at least the method in the third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example of 4-step RACH procedure supported in 3GPP Release 15;

FIG. 2 illustrates 13 types of preamble format supported in 5G NR;

FIGS. 3A-3C illustrate some examples of flexible full duplexing solution for unpaired bands;

FIGS. 4A-4C illustrate some schematic diagrams of a CLI scenario;

FIG. 5 illustrates an example of a network environment in which some example embodiments of the present disclosure may be implemented;

FIG. 6 illustrates an example of a process flow in accordance with some example embodiments of the present disclosure;

FIGS. 7A-7B illustrate examples of two different RACH formats in a same time-frequency resources in accordance with some example embodiments of the present disclosure;

FIGS. 8A-8B illustrate examples of SSB mapping in accordance with some example embodiments of the present disclosure;

FIG. 9 illustrates some examples of SSB mapping for three different cases in accordance with some example embodiments of the present disclosure;

FIG. 10 illustrates an example of a CLI area in accordance with some example embodiments of the present disclosure;

FIG. 11 illustrates an example of a process flow performed by a UE in accordance with some example embodiments of the present disclosure;

FIG. 12 illustrates a flowchart of a method implemented at a terminal device in accordance with some example embodiments of the present disclosure;

FIG. 13 illustrates a flowchart of a method implemented at a network device in accordance with some example embodiments of the present disclosure;

FIG. 14 illustrates a simplified block diagram of a device that is suitable for implementing some example embodiments of the present disclosure; and

FIG. 15 illustrates a block diagram of an example of a computer readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), New Radio (NR), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) NB (also referred to as a gNB), a Remote Radio Unit (RRU), a radio header (RH), a remote radio head (RRH), an integrated access and backhaul (IAB) node, a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a machine type communication (MTC) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Random access (RA) procedure refers to a procedure in which the UE can synchronize with its serving cell and can obtain initial resources for uplink (UL) transmission. For example, the RA procedure may be related with a state of the UE switching from a radio resource control (RRC) idle state or an RRC inactive state to an RRC connected state.

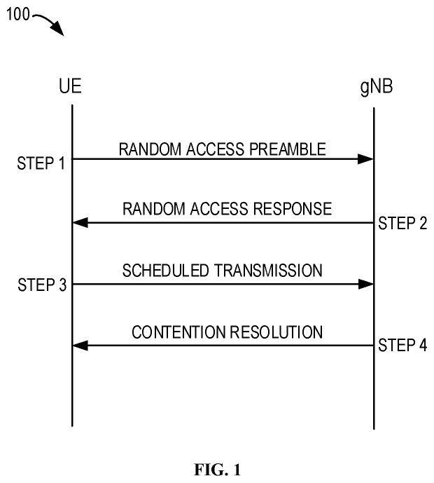

FIG. 1 illustrates an example of 4-step RACH procedure 100 supported in 3GPP Release 15 (R15). As shown in FIG. 1, the four steps include: 1, the UE transmits a random access preamble in a so-called Msg 1 to the gNB. 2, the gNB, upon receiving the preamble, replies to the UE by sending in the physical downlink shared channel (PDSCH) the detected preamble ID, the time-advance command, a temporary cell-radio network temporary identifier (TC-RNTI), and a UL grant for the transmission of Msg3 on physical uplink shared channel (PUSCH). 3, the UE responds to Msg2 over the scheduled PUSCH with an ID for contention resolution. 4, the gNB transmits the contention resolution message with the contention-resolution ID. Upon reception of Msg4, the UE sends an acknowledge (ACK) on a physical uplink control channel (PUCCH) if its contention-resolution ID is carried by Msg4. This completes the 4-step RACH procedure.

In addition to 4-step RACH procedure, there is also a 2-step RACH procedure for partitioning of RACH resources as defined in 3GPP R16, which can improve the overall latency of the RACH procedure.

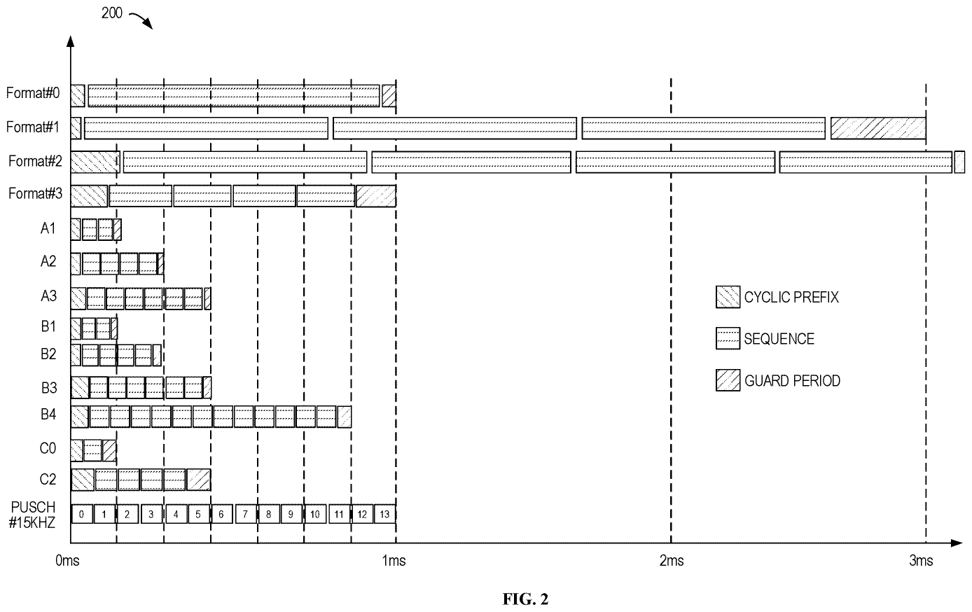

A preamble is send by UE to gNB over PRACH channel to obtain the UL synchronization. Similar to LTE, in 5G NR there are 64 preambles defined in each time-frequency PRACH occasion. The preamble consists of three parts: cyclic prefix (CP), Preamble Sequence, and Guard Period (GP). FIG. 2 illustrates 13 types of preamble format 200 supported in 5G NR. As shown in FIG. 2, the 13 types of preamble format include Format 0, Format 1, Format 2, Format 3, Format A1, Format A2, Format A3, Format B1, Format B2, Format B3, Format B4, Format C0, Format C1.

The UE behavior for random access is based on the settings and values indicated in RACH-ConfigCommon and RACH-ConfigGeneric information elements (IE) provided via RRC signaling, which has listed in 3GPP TS 38.331.

3GPP has agreed to initiate a release 18 (R18) study item on the evolution of duplexing operation in NR. One of the objectives of the study item is to allow simultaneous DL and UL transmission on different physical resource blocks (PRBs)/subbands within an unpaired wideband NR cell, which may be called as a subband non-overlapping full duplex (SBFD). In the context of the present disclosure, the duplexing scheme of SBFD may also be referred to as a cross-division duplexing (xDD) scheme or a Flexible Duplexing (FDU) scheme.

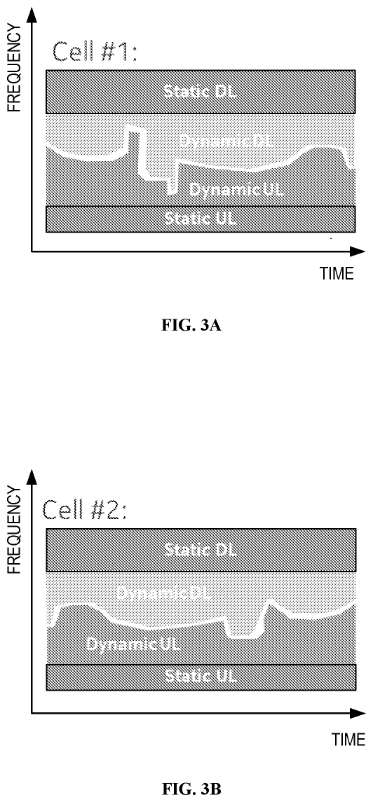

FIGS. 3A-3C illustrate some examples of flexible full duplexing solution for unpaired bands. Each carrier (cell) has static downlink (DL) and uplink (UL) transmission frequency domains, dynamic downlink and uplink frequency domains.

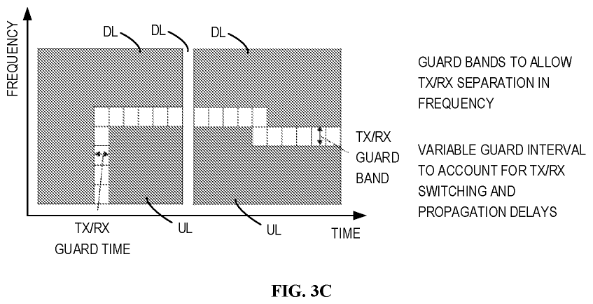

SBFD may introduce at least one cross-link interference (CLI) type, which may be named as co-channel inter-subband CLI. FIGS. 4A-4C illustrate some examples of CLI scenarios at both UE and gNB side.

FIG. 4A illustrates a schematic diagram 410 of a CLI scenario. It is assumed that UE 411 is within a cell of gNB 401, UE 412 is within a cell of gNB 402, and they are operated in half-duplex (HD). There may be an inter-cell interference 419 between a downlink transmission from gNB 401 to UE 411 and a downlink transmission from gNB 402 to UE 412 as shown in FIG. 4A.

FIG. 4B illustrates a schematic diagram 420 of another CLI scenario. It is assumed that UE 421 and UE 422 are within the cell of gNB 403, the UEs 421 and 422 are in HD and the gNB 403 is in full-duplex (FD). There may be a self-interference 428 or an intra-cell interference 429.

FIG. 4C illustrates a schematic diagram 430 of a further CLI scenario. It is assumed that UE 431 is within a cell of gNB 404, and UE 432 is within a cell of gNB 405, and they are operated in bi-directional FD. There may be an inter-cell interference 435, a self-interference 436, or a further inter-cell interference 438. The inter-cell interference 435 is similar with the inter-cell interference 419 in FIG. 4A. The inter-cell interference 438 could be an inter-cell UE-to-UE co-channel CLI or a gNB-to-gNB co-channel CLI.

It is understood that some UEs may be located near an edge of a serving cell, which may be referred to as cell-edge UEs or coverage shortage UEs. In practice, a network device may configure a long PRACH preamble, which offers better coverage than short PRACH preamble due to the higher number of sequence repetitions, for cell-edge UEs. However, when multiple synchronization signal blocks (SSBs) are associated, such long PRACH preamble incurs in large delay for the initial access of all UEs in the cell. In other words, although long PRACH preamble may enable network access to cell-edge/coverage shortage UEs, it increases the access delay of all the UEs in the cell and subsequently their collision probability (including those UEs not requiring long PRACH preamble for reliable network access, i.e., UEs that are not in cell-edge or coverage shortage). Further, the current configuration cannot be well adapted to the flexible deployment of FDU and will increase the delay and increase the interference.

It is straightforward that the PRACH collision probability is disproportional to the number of resources available in a given time interval. Therefore, there is a larger collision probability for longer PRACH preamble compared to shorter PRACH preamble. For example, a network device could configure up to one PRACH occasion in one frame for PRACH format 2 (i.e., PRACH configuration index 58 or 59) or configure up to 10 different PRACH occasions in one frame for PRACH format 0 (i.e., PRACH configuration index 27).

Example embodiments of the present disclosure provide a solution for flexible PRACH operation. Especially, a terminal device may receive RACH configuration information indicating at least two PRACH configuration indexes. As such, the terminal device may select one from the at least two PRACH configuration indexes and transmit a preamble based on the selected PRACH configuration index. Thus, a terminal device can choose a proper preamble based on its situation, for example, a cell-edge UE may use a long preamble and a UE in the center of the cell may use a short preamble. Therefore, the access delay can be reduced and the efficiency of access can be improved. Principles and some example embodiments of the present disclosure will be described in detail below with reference to the accompanying drawings.

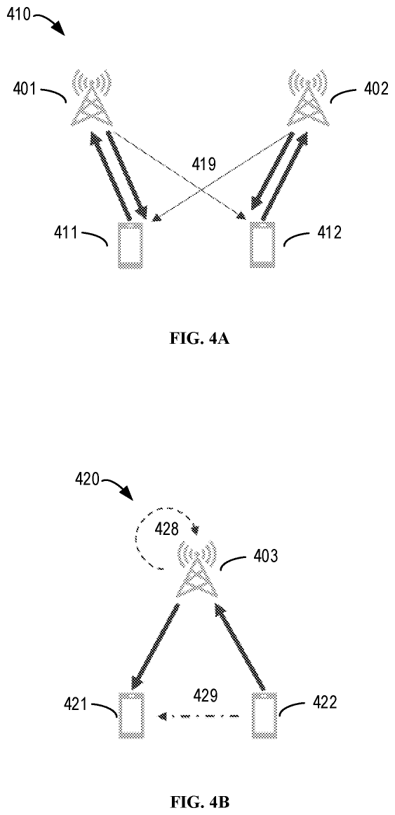

FIG. 5 illustrates an example of a network environment 500 in which some example embodiments of the present disclosure may be implemented. The environment 500, which may be a part of a communication network, comprises a terminal device 510 and a network device 520.

The communication environment 500 may comprise any suitable number of devices and cells. In the communication environment 500, the network device 520 can provide services to the terminal device 510, and the network device 520 and the terminal device 510 may communicate data and control information with each other. In some embodiments, the network device 520 and the terminal device 510 may communicate with direct links/channels.

In the system 500, a link from the network device 520 to the terminal device 510 is referred to as a downlink (DL), while a link from the terminal device 510 to the network device 520 is referred to as an uplink (UL). In downlink, the network device 520 is a transmitting (TX) device (or a transmitter) and the terminal device 510 is a receiving (RX) device (or a receiver). In uplink, the terminal device 510 is a transmitting TX device (or a transmitter) and the network device 520 is a RX device (or a receiver). It is to be understood that the network device 520 may provide one or more serving cells. In some embodiments, the network device 520 can provide multiple cells.

Communications in the network environment 500 may be implemented according to any proper communication protocol(s), comprising, but not limited to, cellular communication protocols of the first generation (1G), the second generation (2G), the third generation (3G), the fourth generation (4G), the fifth generation (5G) and the sixth generation (6G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the numbers of devices (i.e., the terminal device 510 and the network device 520) and their connection relationships and types shown in FIG. 5 are only for the purpose of illustration without suggesting any limitation. For example, the environment 500 may include any suitable numbers of devices adapted for implementing embodiments of the present disclosure. For example, while FIG. 5 depicts the terminal device 510 as a mobile phone, the terminal device 510 may be any type of user equipment.

In some example embodiments, the network device 520 may use a flexible full duplex network or a dynamic TDD network. In some example embodiments, the terminal device 510 may support FDU, and the terminal device 510 may be a FDU-aware UE. In the present disclosure, the term “FDU-aware UE” may be used interchangeable with any one of the terms “mixed PRACH mode aware UE”, “mixed PRACH format aware UE”, “mixed PRACH capable UE”, “UE with mixed PRACH capability”, “UE with mix PRACH mode capability”, or the like, the present disclosure does not limit this aspect.

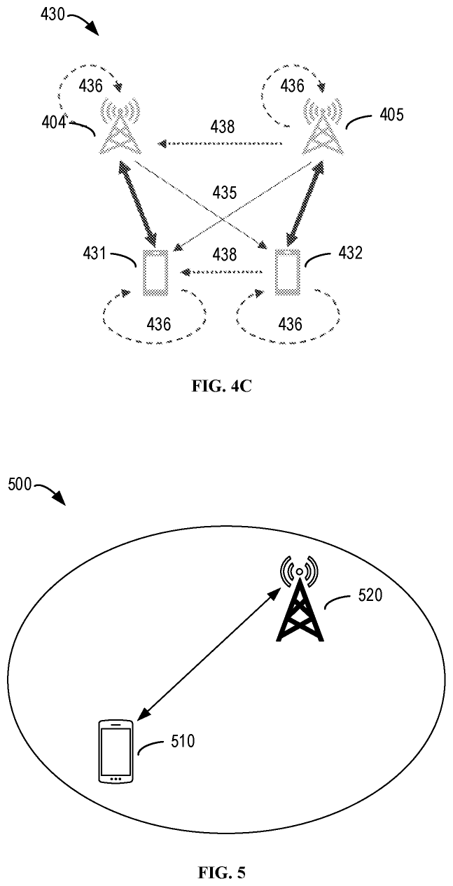

FIG. 6 illustrates an example of a process flow 600 in accordance with some example embodiments of the present disclosure. For the purpose of discussion, the process flow 600 will be described with reference to FIG. 5. The process flow 600 involves a terminal device 510 and a network device 520. It would be appreciated that although the process flow 600 has been described in the network environment 500 of FIG. 5, this process flow may be likewise applied to other communication scenarios.

The network device 520 transmits RACH configuration information 612 to the terminal device 510. In some example embodiments, the RACH configuration information may be carried in an RRC message or RRC signalling. For example, the network device 520 may transmit the RRC message/signalling which include the RACH configuration information 612.

The configuration information 612 may indicate at least two PRACH configuration indexes. In some examples, the configuration information 612 may indicate a mixed PRACH format or a mixed PRACH mode which include at least two PRACH configuration indexes. For ease of description, it is assumed that two PRACH configuration indexes are included. In some examples, the two PRACH configuration indexes may comprises a legacy PRACH configuration index and a new PRACH configuration index, where the legacy PRACH configuration index can also be called as a default PRACH configuration index, the new PRACH configuration index can also be called as a secondary PRACH configuration index.

In some example embodiments, the at least two PRACH configuration indexes may include a first PRACH configuration index and a second PRACH configuration index. The first PRACH configuration index may indicate a first PRACH format, and the second PRACH configuration index may indicate a second PRACH format. In some examples, the first PRACH format and the second PRACH format may be the same format, or may be different format.

In some examples, the at least two PRACH configuration indexes may indicate two or more PRACH formats in the same time-frequency resource (same PRBs, same slots/symbols). For example, the time-frequency resource of the first PRACH format and the time-frequency resource of the second PRACH format may be overlapped. As such, the present disclosure provides a method to use the same time-frequency resources for different PRACH formats within the cell. In some examples, the at least two PRACH configuration indexes may be with a same sub-carrier space (SCS). As such, the present disclosure provides a solution that can mix any same SCS with different PRACH formats for different scenario in same time and frequency resources. For example, a first PRACH format can be flexible combined with a second PRACH format with a same SCS in a same time-frequency resource.

For ease of description, it is assumed that the first PRACH format is associated with a longer RACH sequence and the second PRACH format is associated with a shorter RACH sequence.

In some examples, the first PRACH configuration index may be the legacy/default PRACH configuration index and the second PRACH configuration index may be the new/secondary PRACH configuration index. In some other examples, the first PRACH configuration index may be the new/secondary PRACH configuration index and the second PRACH configuration index may be the legacy/default PRACH configuration index. In other words, the legacy/default PRACH configuration index may be associated with a longer RACH sequence or a shorter RACH sequence, depending on the configuration by the network device 520.

In some examples, the legacy/default PRACH configuration index and the new/secondary PRACH configuration index may be carried in IEs “prach-ConfigurationIndex” and “prach-ConfigurationIndex-new” respectively.

In some example embodiments, the RACH configuration information 612 may further indicate at least one threshold. In some examples, the at least one threshold can be used by the terminal device 510 for selecting a proper PRACH configuration index. The threshold may be related to signal strength, path loss, or coverage. For example, the at least one threshold may include one or more of: a reference signal receiving power (RSRP) threshold, a reference signal receiving quality (RSRQ) threshold, a path loss threshold, or a signal to interference plus noise ratio (SINR) threshold.

In some examples, in case there are more than two PRACH configuration indexes indicated by the RACH configuration information 612, there may be more than one threshold for selecting the PRACH configuration index. For example, there are N (is an integer greater than 1) PRACH configuration indexes, and there may be N−1 RSRP thresholds. In some examples, the least one threshold may be carried in an IE “rsrp-ThresholdSSB-new”.

In some examples, the at least threshold can be used by the terminal device 510 for determining whether a maximum attempts has been reached. For example, the at least one threshold may include a transmission attempts threshold. As such, a maximum number of transmission attempts can be defined or configured by the network device 520, and the terminal device 510 may fall back to the legacy RACH procedure if the maximum number is reached.

In some example embodiments, the RACH configuration information 612 may further indicate an SSB mapping for RACH occasions (ROs). In some examples, the SSB mapping may include a first mapping between a first set of ROs and a first set of SSBs, and a second mapping between a second set of ROs and a second set of SSBs, where the first set of ROs are associated with (or determined by) the first PRACH configuration index, and the second set of ROs are associated with (or determined by) the second PRACH configuration index. In some examples, the SSB mapping may be carried in an IE “ssb-perRACH-OccasionAndCB-PreamblesPerSSB-new”.

In some examples, the number of ROs in the first set of ROs may be represented as N1, the number of SSBs in the first set of SSBs may be represented as N2, and N1≥N2, where both N1 and N2 are integer. Similarly, the number of ROs in the second set of ROs may be represented as N3, the number of SSBs in the second set of SSBs may be represented as N4, and N3≥N4, where both N3 and N4 are integer. In other words, there may be more than two ROs mapped to a same SSB. In some examples, the first set of ROs and the second set of ROs are determined within a slot.

On the other side on communication, the terminal device 510 receives 614 the RACH configuration information 612. The terminal device 510 selects 620 one PRACH configuration index from the at least two PRACH configuration indexes. In some example embodiments, the terminal device 510 may determine a measurement result, and further selects one of the at least two PRACH configuration indexes based on the measurement result.

In some example embodiments, the measurement result may be determined based on one or more of: an RSRP measurement, an RSRQ measurement, a path loss measurement, a SINR measurement or the like. In some other example embodiments, the measurement result may be determined based on a distance to the network device 520.

It is assume that the at least two PRACH configuration indexes include a first PRACH configuration index associated with a long RACH sequence and a second PRACH configuration index associated with a short RACH sequence. The terminal device 510 may select the long or short RACH sequence based on the measurement result, and thus the PRACH configuration index associated with the selected RACH sequence is determined.

In some examples, the terminal device 510 may select the long RACH sequence if the measurement result indicates one or more of: a measured RSRP is below an RSRP threshold, a measured path loss exceeds a path loss threshold, or a measured SINR is below a SINR threshold. In some other examples, the terminal device 510 may select the short RACH sequence if the measurement result indicates one or more of: a measured RSRP exceeds a RSRP threshold, a measured path loss is below a path loss threshold, or a measured SINR exceeds a SINR threshold.

In some examples, a selection condition (or criteria) may be defined, and the terminal device 510 can select the long RACH sequence if the selection condition is met. For example, the selection condition can be one or more of: (c1) a measured RSRP is below a RSRP threshold, (c2) a measured path loss exceeds a path loss threshold, or (c3) a measured SINR is below a SINR threshold. It is understood that although some specific examples are listed here as the selection condition, they are described only for the purpose of illustration without suggesting any limitation, for example, the selection condition (or criteria) may be related to one of: inter-cell interference, intra-cell interference, coverage shortage, or the like, thus the selection condition (or criteria) may be defined by considering different scenarios.

As such, the present disclosure provides a method for the terminal device 510 to decide which of the at least two PRACH configuration index to be chose, and accordingly decide which RACH sequence to be used for PRACH transmission. For a specific example, if the DL RSRP measured by the terminal device 510 is below the RSRP threshold indicated by the network device 520, the terminal device 510 can select and use a longer sequence (more robust PRACH format).

The terminal device 510 transmits the RACH preamble 632 to the network device 520. In some examples, if a long RACH preamble is selected, the terminal device 510 may transmit the long RACH preamble. In some other examples, if a short RACH preamble is selected, the terminal device 510 may transmit the short RACH preamble.

In some example embodiments, the RACH preamble 632 may be transmitted in a specific RO. In some examples, the terminal device 510 may determine the SSB associated with the measurement result, and determine the RO based on the SSB. For example, if the terminal device 510 selects the second PRACH configuration index at 620 and the measurement result indicates an SSB-RSRP of a specific SSB, then the terminal device 510 may determine the specific RO based on the first mapping indicated by the RACH configuration information 612. Since there is a mapping between the specific SSB and the specific RO, the terminal device 510 can transmit 630 the RACH preamble 632 in the specific RO.

Additionally or alternatively, the terminal device 510 may further determine a number of transmission attempts of the RACH preamble 632. For example, a counter may be used for counting the total number of transmission attempts of the RACH preamble 632. The terminal device 510 may compare the number of transmission attempts with a transmission attempts threshold indicated by the network device 520, and determine whether the number of transmission attempts exceeds the transmission attempts threshold.

In some examples, if the number of transmission attempts does not exceed the transmission attempts threshold, the terminal device 510 may transmit the RACH preamble 632, and the counter can be added 1. In some other examples, if the number of transmission attempts exceeds the transmission attempts threshold, the terminal device 510 may fall back to a legacy PRACH procedure. For example, the terminal device 510 may transmit the legacy/default preamble associated with the legacy/default PRACH configuration index to the network device 520. For example, the terminal device 510 may ignore the measurement result and reset the counter.

On the other side of communication, the network device 520 receives 634 the RACH preamble 632. In some example embodiments, the network device 520 may identify whether the received RACH preamble 632 is associated with the legacy/default PRACH configuration index or the new/secondary PRACH configuration index. In some examples, if the network device 520 determines that the received RACH preamble 632 is associated with new/secondary PRACH configuration index (not the legacy/default PRACH configuration index), then the network device 520 may determine that the terminal device 510 is a mixed PRACH capable UE (or FDU-aware UE).

As such, the solution offers a possibility for the network device 520 to identify the terminal device 510 in coverage-limited and/or interference-limited scenarios and if the terminal device 510 is FDU-aware UE, by looking at the received RACH preamble 632 from the terminal device 510.

Additionally or alternatively, the network device 520 may receive a further RACH preamble from a further terminal device. In some examples, the RACH preamble 632 and the further RACH preamble may be different preambles, for example, the RACH preamble 632 is associated with the first PRACH configuration index and the further RACH preamble is associated with the second PRACH configuration index; for another, the RACH preamble 632 is associated with the second PRACH configuration index and the further RACH preamble is associated with the first PRACH configuration index.

In some example embodiments, the network device 520 may perform signal processing procedures for the RACH preamble 632 and the further RACH preamble. In some examples, the network device 520 may process the RACH preamble 632 by considering interference from the further RACH preamble, and may process the further RACH preamble by considering interference from the RACH preamble 632.

According to the example embodiments with reference to FIG. 6, a terminal device may select one PRACH configuration index from the at least two PRACH configuration indexes configured by the network device, and transmit a preamble based on the selected PRACH configuration index. Since at least two PRACH configuration indexes are configured, the present disclosure can be applied to different scenarios. The solution allows more flexible scenarios by means of using less time-frequency resources, and thus can reduce latency, decrease power consumption and interference; therefore, the random access can be successful.

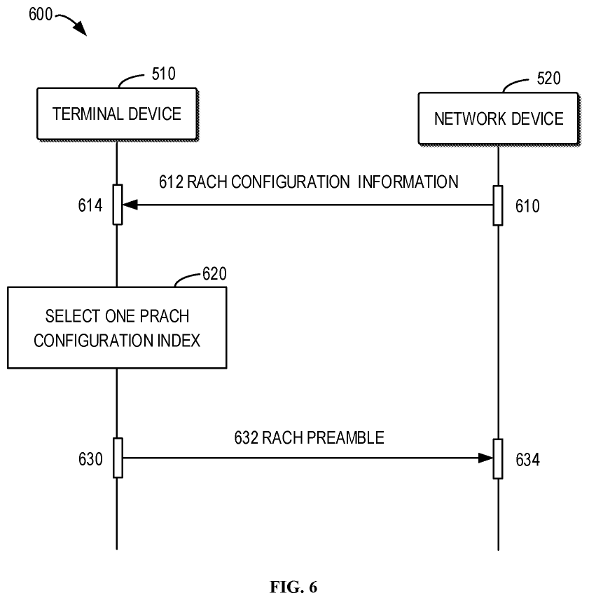

FIG. 7A illustrates an example 710 of two different RACH formats in a same time-frequency resources. As shown in FIG. 7A, a RACH format A1 712 is mixed with a RACH format C2 714 in a same time-frequency resources 716, for example the same slot with symbols 0-13. Specifically, the same time resources symbols 0-3 and 6-9 are occupied by both the RACH format A1 and the RACH format C2. FIG. 7B illustrates another example 720 of two different RACH formats in a same time-frequency resources. As shown in FIG. 7B, a RACH format A2 722 is mixed with a RACH format B4 724 in a same time-frequency resources 726, for example the same slot with symbols 0-13. Specifically, the same time resources symbols 0-10 are occupied by both the RACH format A2 and the RACH format B4.

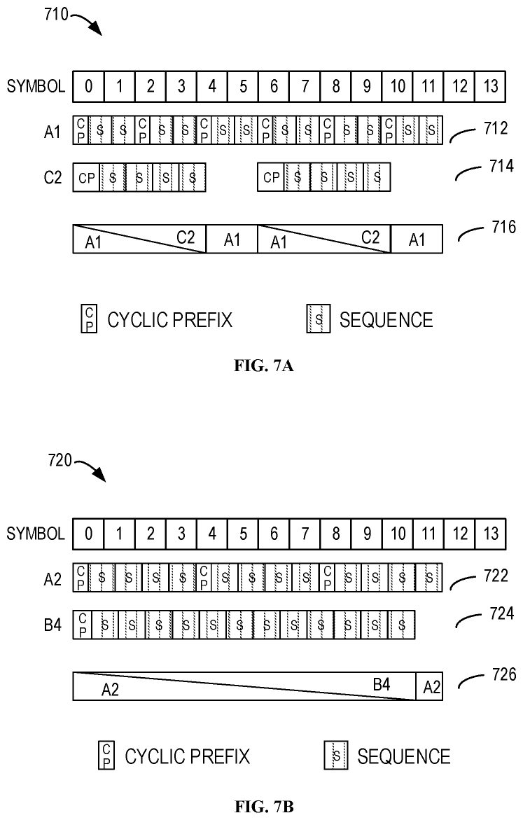

FIG. 8A illustrates an example 810 of SSB mapping. As shown in FIG. 8A, a RACH format A1 812 is mixed with a RACH format C2 814 in a same time-frequency resources. There are 6 ROs of the RACH format A1 812 which are associated with SSB1 to SSB6 respectively, that is, the 6 ROs of the RACH format A1 812 are mapped with 6 different SSBs. There are 2 ROs 816 and 818 of the RACH format C2 814 which are associated with SSB1 and SSB2 respectively, that is, the 2 ROs of the ACH format C2 814 are mapped with 2 different SSBs. Therefore, the two RACH formats have different mapping relationships with the SSBs and have different access periods.

In some examples, if the PRACH period is 10 ms, then it may need 30 ms for the RACH format C2 814 to bundle with 6 SSBs, while only 10 ms is needed for the RACH format A1 812 to bundle with 6 SSBs. Therefore, the latency can be significantly reduced for initial access without additional frequency resources. For example, if there are two different UEs use the same time to camp on the same SSB (such as SSB #3), then one UE with the RACH format A1 812 will access 20 ms in advance compared with the other UE with the RACH format C2 814.

From the perspective of the network device, considering the first two ROs of RACH format A1 812, i.e., symbols 0-3, if both the RACH format A1 812 and the RACH format C2 814 are received, that is, if the network device receives a preamble of the RACH format A1 812 from a UE and receives another preamble of the RACH format C2 814 from another UE, there is no additional increased interference for different random access preamble formats compare with two UEs using a same PRACH format. Specifically, if a UE transmits preamble of the RACH format A1 812, the interference to another UE which transmits the preamble of the RACH format C2 814 is lower than the case in which both UEs transmit the preamble of the RACH format C2 814, because only one repetition (excluding CP) of the preamble of the RACH format C2 814 will be affected by interference of the preamble of the RACH format A1 812. Although the other repetition of the preamble of the RACH format C2 814 may be interfered by other UEs transmitting on other SSB beams, the interference would be lower because of the spatial filtering.

In terms of implementation, layer 1 can handle different PRACH formats separately, and at the same time can improve the reception performance by comparing results and interference suppression eliminating. In the case of FDU cells, and assuming that every slot may support both DL and UL, the network device could benefit from the shortest time access process for MSG2, MSG3, etc.

FIG. 8B illustrates an example 820 of SSB mapping. As shown in FIG. 8B, a RACH format A1 822 is mixed with a RACH format C2 824 in a same time-frequency resources. There are 6 ROs of the RACH format A1 822 which are associated with SSB1 to SSB6 respectively, and there are 2 ROs 826 and 828 of the RACH format C2 824 which are both associated with SSB1. It is understood that in case a short RACH preamble is used, the RACH process delay can be reduces due to bundling of ROs with SSB beams, since the short RACH preamble enables more ROs in time domain. It is understood that in case a long RACH preamble is used, PRACH would be more robust in CLI and coverage shortage scenario.

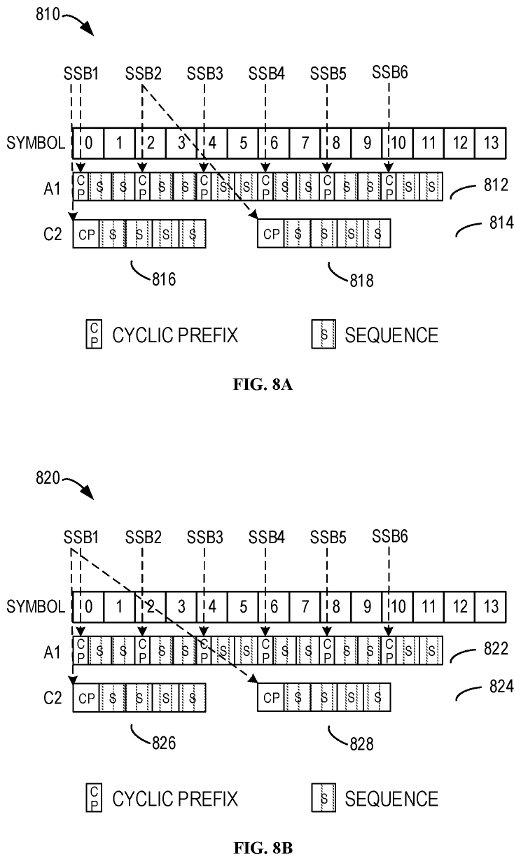

FIG. 9 illustrates some examples of SSB mapping 900 for three different cases. As shown in block 910, in case the number of FDM instances is 1 and the number of SSB per RO is 1, there is only one SSB that mapped to a RO. As shown in block 920, in case the number of FDM instances is 1 and the number of SSB per RO is 2, there are two SSBs that mapped to a RO. As shown in block 930, in case the number of FDM instances is 4 and the number of SSB per RO is 1, there are one SSB that mapped to a RO.

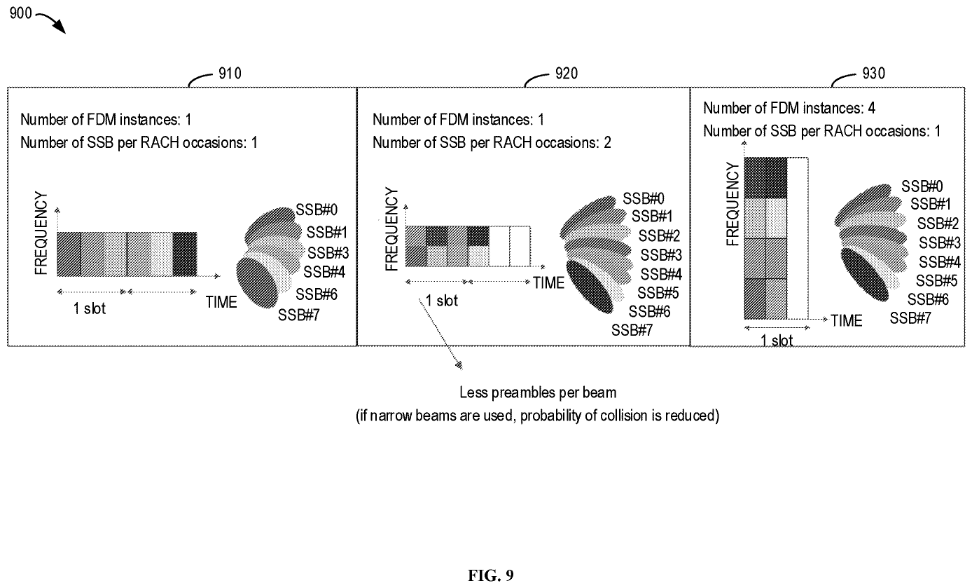

FIG. 10 illustrates an example 1000 of a CLI area. As shown in FIG. 10, the UE 1012 and the UE 1014 are located in the CLI area 1010, and they may use long preamble (such as format 1/2) to access. As described above, in case the measured DL RSRP exceeds the RSRP threshold (i.e., the DL signal strength is good, or the distance to the network device is less than a distance threshold), a short preamble (such as, format 0/C0/A2/C2) may be used for initial accessing. As such, the capacity of access can be larger, the power consumption can be lower, and the interference between cells and UEs can be reduced too. At the same time, the CLI area can be controlled by independently controlling the new PRACH format, for example, by controlling the Ncs (zeroCorrelationZoneConfig) value to control cell access radius.

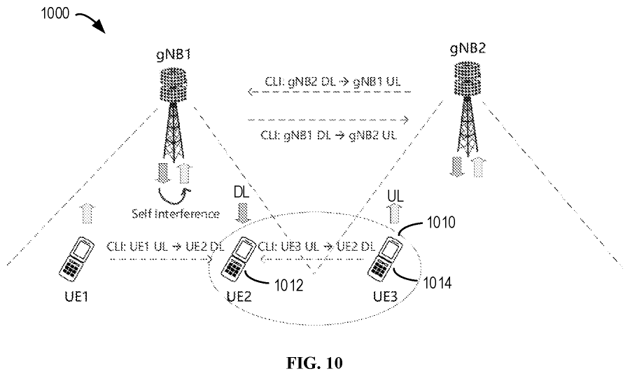

FIG. 11 illustrates an example of a process flow 1100 performed by a UE. The UE which performs the process 1100 may be a legacy UE or a mixed PRACH capable UE (such as the terminal device 510). The legacy UE may be a terminal device without a mixed PRACH capability.

It is assumed that the RACH configuration information is configured by the network device by “rach-ConfigGeneric” via an RRC message/signalling:

```
rach-ConfigCommon: setup (1)
setup
  rach-ConfigGeneric
    prach-ConfigurationIndex: 156
        ------------------prach B4 (legacy UE)
    prach-ConfigurationIndex-new: 96
      ------------------prach A2 (mixed PRACH format aware UE)
    msg1-FDM: one (0)
    msg1-FrequencyStart: 0
    zeroCorrelationZoneConfig: 13
    preambleReceivedTargetPower: −104dBm
    preambleTransMax: n10 (6)
    powerRampingStep: dB2 (1)
    ra-ResponseWindow: sl10 (4)
  ssb-perRACH-OccasionAndCB-PreamblesPerSSB: one (3)
    one: n8 (1)
  ssb-perRACH-OccasionAndCB-PreamblesPerSSB-new: one (3)
    one: n8 (1)------------------------------------ (mixed PRACH format
aware UE)
  ra-ContentionResolutionTimer: sf64 (7)
  rsrp-ThresholdSSB: −146dBm <= SS-RSRP < −145dBm (11)
  rsrp-ThresholdSSB-new: −146dBm <= SS-RSRP < −145dBm (11)
  prach-RootSequenceIndex: 1139 (1)
    1139: 0
  msg1-SubcarrierSpacing: kHz30 (1)
  restrictedSetConfig: unrestrictedSet (0)
```

The RRC message/signalling includes the new added “prach-ConfigurationIndex-new” parameter, “rsrp-ThresholdSSB-new” parameter, and “ssb-perRACH-OccasionAndCB-PreamblesPerSSB-new” parameter.

The RACH configuration information indicates two different PRACH configuration indexes (prach-ConfigurationIndex and prach-ConfigurationIndex-new): 156 and 96, where the PRACH configuration index 156 is associated with a PRACH format B4, and the PRACH configuration index 96 is associated with a PRACH format A2. The PRACH configuration index 156 is a legacy/default PRACH configuration index, and the PRACH configuration index 96 is a new/secondary PRACH configuration index. Table 1 below shown an example of the association of the PRACH configuration index and the PRACH format.

TABLE 1

| | | | | | | Number | Number |
|---|---|---|---|---|---|---|---|
| | | | | | | of | of time- |
| | | | | | | PRACH | domain |
| PRACH | | n_{SFN} | | | | slots | ROs within |
| configuration | Preamble | mod x = y | | Subframe | Starting | within a | a RACH |
| index | format | x | y | number | symbol | subframe | slot |
| 96 | A2 | 1 | 0 | 2 | 0 | 1 | 3 |
| 156 | B4 | 1 | 0 | 2 | 0 | 1 | 1 |

The RACH configuration information indicates a threshold (rsrp-ThresholdSSB-new), for example the RSRP threshold (SS-RSRP).

In this example, the legacy/default PRACH configuration index is associated with a longer preamble and the new/secondary PRACH configuration index is associated with a shorter preamble.

At 1110, a random access procedure is initiated. For example, the UE may initiate the search cell procedure, finds a suitable SSB (such as SSB #3) to read master information block (MIB) and decodes system information block 1 (SIB1) for getting the RACH configuration information. At 1120, it is determined whether the UE is a mixed PRACH capable UE? If the UE is not a mixed PRACH capable UE, in other words, the UE is a legacy UE, then a legacy/default PRACH configuration index is used at 1130. In some examples, the legacy/default PRACH configuration index is valid for the legacy UE while the new/secondary PRACH configuration index is invalid. It can ensure that the normal coverage access distance of the network device remains unchanged for the legacy UE. Thus, the new RACH configuration can work with the legacy work in compatibility.

If the UE is mixed PRACH capable UE, then a DL SSB-RSRP can be determined (or measured) at 1125. At 1128, the determined DL SSB-RSRP is compared with the threshold, to determine whether the determined DL SSB-RSRP is below the threshold? If the determined DL SSB-RSRP is below the threshold, a longer preamble may be needed. If the determined DL SSB-RSRP exceeds the threshold, a shorter preamble may be needed. In this example, a legacy/default PRACH configuration index is used at 1130 if the determined DL SSB-RSRP is below the threshold; and a new/secondary PRACH configuration index is used at 1140 if the determined DL SSB-RSRP exceeds the threshold.

At 1150, the RACH transmission is performed. For example, if the UE is a mixed PRACH capable UE, the UE may determine a RO associated with the suitable SSB (such as SSB #3), and transmit preamble in the RO (such as the third RO in a slot).

It is to be understood that the example in FIG. 11 is only for the purpose of illustration without suggesting any limitation. For example, the network device may determine different RACH configuration information for different scenarios, for example, the PRACH format C0 may be used for FDU or low latency scenario. For example, the criteria for selecting the PRACH configuration index could be related to a path loss, SINR, access type, a distance, or the like. For example, there may be a parameter “path-loss-Threshold-new” in the RRC message/signalling to indicate a maximum path loss threshold. For example, if the access type is ultra-reliable low latency communication (URLLC), which means the UE requires low latency, then a short preamble may be used, i.e, the UE may select new/secondary PRACH configuration index. For example, if the UE is near to the network device (such as gNB), for example the distance is less than a distance threshold, then a short preamble may be used, i.e, the UE may select the new/secondary PRACH configuration index. For example, if the UE is far from the the network device (such as gNB), for example the distance is greater than a distance threshold, then a long preamble may be used, i.e, the UE may select the legacy/default PRACH configuration index, since the long preamble may have high gain and large distance in the access process.

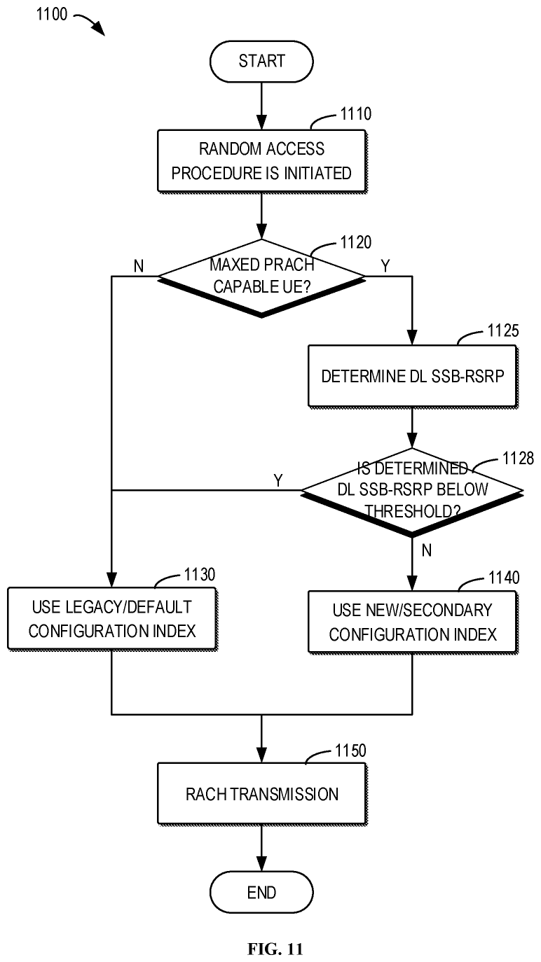

FIG. 12 illustrates a flowchart 1200 of a method implemented at a terminal device in accordance with some example embodiments of the present disclosure. For the purpose of discussion, the method 1200 will be described from the perspective of the terminal device 510 with reference to FIG. 5.

At block 1210, the terminal device 510 receives, from a network device 520, random access channel (RACH) configuration information indicating at least two physical random access channel (PRACH) configuration indexes. At block 1220, the terminal device 510 selects one PRACH configuration index from the at least two PRACH configuration indexes. At block 1230, the terminal device 510 transmits, to the network device 520, a RACH preamble based on the selected PRACH configuration index

In some example embodiments, the terminal device 510 receives the RACH configuration information via a radio resource control (RRC) message, where the RACH configuration information indicates the at least two PRACH configuration indexes and at least one of: a reference signal receiving power (RSRP) threshold, a reference signal receiving quality (RSRQ) threshold, a path loss threshold, a signal to interference plus noise ratio (SINR) threshold, or a transmission attempts threshold.

In some example embodiments, the at least two RACH configuration indexes comprise a first RACH configuration index associated with a first PRACH preamble and a second RACH configuration index associated with a second PRACH preamble. The terminal device 510 selects a longer one of the first PRACH preamble or the second PRACH preamble based on determining that a measurement result indicates at least one of: a measured RSRP is below an RSRP threshold, a measured path loss exceeds a path loss threshold, or a measured SINR is below an SINR threshold.

In some example embodiments, the terminal device 510 selects a shorter one of the first PRACH preamble or the second PRACH preamble based on determining that a measurement result indicates at least one of: a measured RSRP exceeds an RSRP threshold, a measured path loss is below a path loss threshold, or a measured SINR exceeds an SINR threshold.

In some example embodiments, the terminal device 510 determines a number of transmission attempts of the PRACH preamble; determines that the number of transmission attempts exceeds a transmission attempts threshold; and based on determining that the number of transmission attempts exceeds a transmission attempts threshold, the terminal device 510 transmits a legacy preamble indicated by the RACH configuration information.

In some example embodiments, the terminal device 510 determines a synchronization signal block (SSB) associated with a measurement result; determines, from at least one random access occasion (RO) of the PRACH preamble, a RO associated with the SSB based on the RACH configuration information; and the terminal device 510 transmits the PRACH preamble in the RO.

In some example embodiments, the RACH configuration information further indicates a mapping between the at least one RO and at least one SSB.

In some example embodiments, a first number of the at least one SSB is less than or equal to a second number of the at least one RO.

In some example embodiments, the terminal device 510 is at least one of: a mixed PRACH capable terminal, or a flexible duplexing (FDU)-aware terminal.

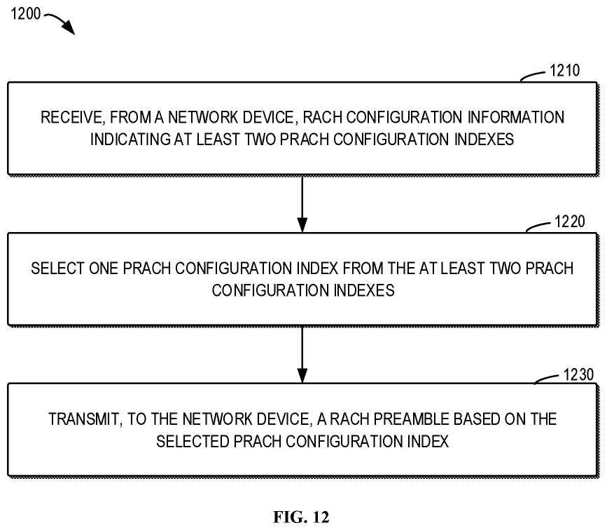

FIG. 13 illustrates a flowchart 1300 of a method implemented at a network device in accordance with some example embodiments of the present disclosure. For the purpose of discussion, the method 1300 will be described from the perspective of the network device 520 with reference to FIG. 5.

At block 1310, the network device 520 transmits, to a terminal device 510, random access channel (RACH) configuration information indicating at least two physical random access channel (PRACH) configuration indexes. At block 1320, the network device 520 receives from the terminal device 510, a PRACH preamble associated with one of the at least two PRACH configuration indexes.

In some example embodiments, the network device 520 transmits the RACH configuration information via a radio resource control (RRC) message, where the RACH configuration information indicates the at least two PRACH configuration indexes and at least one of: a reference signal receiving power (RSRP) threshold, a reference signal receiving quality (RSRQ) threshold, a path loss threshold, a signal to interference plus noise ratio (SINR) threshold, or a transmission attempts threshold.

In some example embodiments, the at least two RACH configuration indexes comprise a first RACH configuration index associated with a first PRACH preamble and a second RACH configuration index associated with a second PRACH preamble, and the RACH configuration information further indicates: a first mapping between a first set of random access occasions (ROs) of the first PRACH preamble and a first set of synchronization signal blocks (SSBs), and a second mapping between a second set of ROs of the second PRACH preamble and a second set of SSBs.

In some example embodiments, a number of ROs in the first set of ROs is greater than or equal to a number of SSBs in the first set of SSBs, and a number of ROs in the second set of ROs is greater than or equal to a number of SSBs in the second set of SSBs.

In some example embodiments, the network device 520 determines that the one of the at least two PRACH configuration indexes is not a legacy configuration index; and based on determining that the one of the at least two PRACH configuration indexes is not a legacy configuration index, the network device 520 determines that the terminal device 510 is a mixed PRACH capable terminal or a flexible duplexing (FDU)-aware terminal.

In some example embodiments, the network device 520 receives, from a further terminal device, a further PRACH preamble associated with another one of the at least two PRACH configuration indexes; and the network device 520 performs signal processing procedures for the PRACH preamble and the further PRACH preamble respectively.

In some example embodiments, an apparatus capable of performing the method 1200 (for example, the terminal device 510) may comprise means for performing the respective steps of the method 1200. The means may be implemented in any suitable form. For example, the means may be implemented in a circuitry or software module.

In some example embodiments, the apparatus comprises: means for receiving, at a terminal device from a network device, random access channel (RACH) configuration information indicating at least two physical random access channel (PRACH) configuration indexes; means for selecting one PRACH configuration index from the at least two PRACH configuration indexes; and means for transmitting, to the network device, a RACH preamble based on the selected PRACH configuration index.

In some example embodiments, the means for receiving the RACH configuration information comprises means for receiving the RACH configuration information via a radio resource control (RRC) message, where the RACH configuration information indicates the at least two PRACH configuration indexes and at least one of: a reference signal receiving power (RSRP) threshold, a reference signal receiving quality (RSRQ) threshold, a path loss threshold, a signal to interference plus noise ratio (SINR) threshold, or a transmission attempts threshold.

In some example embodiments, the at least two RACH configuration indexes comprise a first RACH configuration index associated with a first PRACH preamble and a second RACH configuration index associated with a second PRACH preamble. The means for selecting one PRACH configuration index comprises means for selecting a longer one of the first PRACH preamble or the second PRACH preamble based on determining that a measurement result indicates at least one of: a measured RSRP is below an RSRP threshold, a measured path loss exceeds a path loss threshold, or a measured SINR is below an SINR threshold.

In some example embodiments, the at least two RACH configuration indexes comprise a first RACH configuration index associated with a first PRACH preamble and a second RACH configuration index associated with a second PRACH preamble. The means for selecting one PRACH configuration index comprises means for selecting a shorter one of the first PRACH preamble or the second PRACH preamble based on determining that a measurement result indicates at least one of: a measured RSRP exceeds an RSRP threshold, a measured path loss is below a path loss threshold, or a measured SINR exceeds an SINR threshold.

In some example embodiments, the apparatus further comprises: means for determining a number of transmission attempts of the PRACH preamble; means for determining that the number of transmission attempts exceeds a transmission attempts threshold; and means for based on determining that the number of transmission attempts exceeds a transmission attempts threshold, transmitting a legacy preamble indicated by the RACH configuration information.

In some example embodiments, the apparatus further comprises: means for determining a synchronization signal block (SSB) associated with a measurement result; means for determining, from at least one random access occasion (RO) of the PRACH preamble, a RO associated with the SSB based on the RACH configuration information; and means for transmitting the PRACH preamble in the RO.

In some example embodiments, the RACH configuration information further indicates a mapping between the at least one RO and at least one SSB.

In some example embodiments, a first number of the at least one SSB is less than or equal to a second number of the at least one RO.

In some example embodiments, the terminal device is at least one of: a mixed PRACH capable terminal, or a flexible duplexing (FDU)-aware terminal.

In some example embodiments, an apparatus capable of performing the method 1300 (for example, the network device 520) may comprise means for performing the respective steps of the method 1300. The means may be implemented in any suitable form. For example, the means may be implemented in a circuitry or software module.

In some example embodiments, the apparatus comprises: means for transmitting, at a network device to a terminal device, random access channel (RACH) configuration information indicating at least two physical random access channel (PRACH) configuration indexes; and means for receiving, from the terminal device, a PRACH preamble associated with one of the at least two PRACH configuration indexes.

In some example embodiments, the means for transmitting the RACH configuration information comprises means for transmitting the RACH configuration information via a radio resource control (RRC) message, where the RACH configuration information indicates the at least two PRACH configuration indexes and at least one of: a reference signal receiving power (RSRP) threshold, a reference signal receiving quality (RSRQ) threshold, a path loss threshold, a signal to interference plus noise ratio (SINR) threshold, or a transmission attempts threshold.

In some example embodiments, the at least two RACH configuration indexes comprise a first RACH configuration index associated with a first PRACH preamble and a second RACH configuration index associated with a second PRACH preamble, and the RACH configuration information further indicates: a first mapping between a first set of random access occasions (ROs) of the first PRACH preamble and a first set of synchronization signal blocks (SSBs), and a second mapping between a second set of ROs of the second PRACH preamble and a second set of SSBs.

In some example embodiments, a number of ROs in the first set of ROs is greater than or equal to a number of SSBs in the first set of SSBs, and a number of ROs in the second set of ROs is greater than or equal to a number of SSBs in the second set of SSBs.

In some example embodiments, the apparatus further comprises: means for determining that the one of the at least two PRACH configuration indexes is not a legacy configuration index; and means for based on determining that the one of the at least two PRACH configuration indexes is not a legacy configuration index, determining that the terminal device is a mixed PRACH capable terminal or a flexible duplexing (FDU)-aware terminal.

In some example embodiments, the apparatus further comprises: means for receiving, from a further terminal device, a further PRACH preamble associated with another one of the at least two PRACH configuration indexes; and means for performing signal processing procedures for the PRACH preamble and the further PRACH preamble respectively.

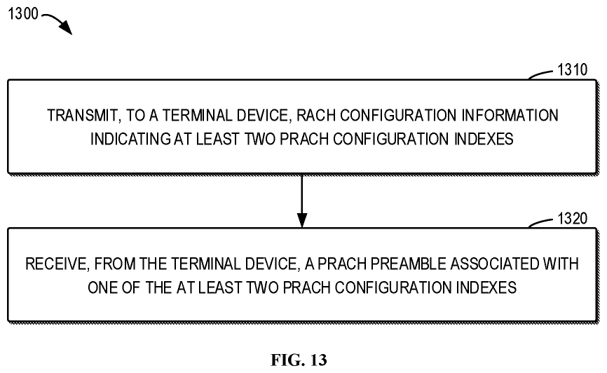

FIG. 14 illustrates a simplified block diagram of a device 1400 that is suitable for implementing some example embodiments of the present disclosure. The device 1400 may be provided to implement the communication device, for example the terminal device 510, or the network device 520 as shown in FIG. 5. As shown, the device 1400 includes one or more processors 1410, one or more memories 1420 coupled to the processor 1410, and one or more communication modules 1440 coupled to the processor 1410.

The communication module 1440 is for bidirectional communications. The communication module 1440 has at least one antenna to facilitate communication. The communication interface may represent any interface that is necessary for communication with other network elements.

The processor 1410 may be of any type suitable to the local technical network and may include one or more of the following: general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

The memory 1420 may include one or more non-volatile memories and one or more volatile memories. Examples of the non-volatile memories include, but are not limited to, a Read Only Memory (ROM) 1424, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1422 and other volatile memories that will not last in the power-down duration.

A computer program 1430 includes computer executable instructions that are executed by the associated processor 1410. The program 1430 may be stored in the ROM 1424. The processor 1410 may perform any suitable actions and processing by loading the program 1430 into the RAM 1422.

The embodiments of the present disclosure may be implemented by means of the program 1430 so that the device 1400 may perform any process of the disclosure as discussed with reference to FIGS. 6-13. The embodiments of the present disclosure may also be implemented by hardware or by a combination of software and hardware.

In some example embodiments, the program 1430 may be tangibly contained in a computer readable medium which may be included in the device 1400 (such as in the memory 1420) or other storage devices that are accessible by the device 1400. The device 1400 may load the program 1430 from the computer readable medium to the RAM 1422 for execution. The computer readable medium may include any types of tangible non-volatile storage, such as ROM, EPROM, a flash memory, a hard disk, CD, DVD, and the like.

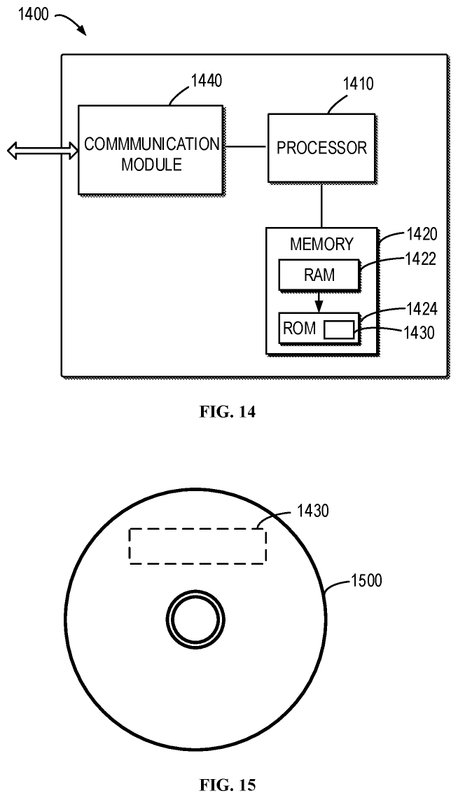

FIG. 15 illustrates a block diagram of an example of a computer readable medium 1500 in accordance with some example embodiments of the present disclosure. The computer readable medium 1500 has the program 1430 stored thereon. It is noted that although the computer readable medium 1500 is depicted in form of CD or DVD in FIG. 15, the computer readable medium 1500 may be in any other form suitable for carry or hold the program 1430.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIGS. 12-13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-20. (canceled)

21. A terminal device comprising:
at least one processor; and
at least one memory storing instructions that, when executed by the at least one processor, cause the terminal device at least to:
receive, from a network device, random access channel (RACH) configuration information indicating at least two physical random access channel (PRACH) configuration indexes;
select one PRACH configuration index from the at least two PRACH configuration indexes; and
transmit, to the network device, a RACH preamble based on the selected PRACH configuration index.

22. The terminal device of claim 21, wherein the at least one memory storing instructions that, when executed by the at least one processor, cause the terminal device to receive the RACH configuration information by:
receiving the RACH configuration information via a radio resource control (RRC) message, wherein the RACH configuration information indicates the at least two PRACH configuration indexes and at least one of:
a reference signal receiving power (RSRP) threshold,
a reference signal receiving quality (RSRQ) threshold,
a path loss threshold,
a signal to interference plus noise ratio (SINR) threshold, or
a transmission attempts threshold.

23. The terminal device of claim 21, wherein the at least two RACH configuration indexes comprise a first RACH configuration index associated with a first PRACH preamble and a second RACH configuration index associated with a second PRACH preamble, and wherein the at least one memory storing instructions that, when executed by the at least one processor, cause the terminal device to select one PRACH configuration index by:
selecting a longer one of the first PRACH preamble or the second PRACH preamble based on determining that a measurement result indicates at least one of:
a measured RSRP is below an RSRP threshold,
a measured path loss exceeds a path loss threshold, or
a measured SINR is below an SINR threshold.

24. The terminal device of claim 21, wherein the at least two RACH configuration indexes comprise a first RACH configuration index associated with a first PRACH preamble and a second RACH configuration index associated with a second PRACH preamble, and wherein the at least one memory storing instructions that, when executed by the at least one processor, cause the terminal device to select one PRACH configuration index by:
selecting a shorter one of the first PRACH preamble or the second PRACH preamble based on determining that a measurement result indicates at least one of:
a measured RSRP exceeds an RSRP threshold,
a measured path loss is below a path loss threshold, or
a measured SINR exceeds an SINR threshold.

25. The terminal device of claim 21, wherein the at least one memory storing instructions that, when executed by the at least one processor, cause the terminal device further to:
determine a number of transmission attempts of the PRACH preamble;
determine that the number of transmission attempts exceeds a transmission attempts threshold; and
based on determining that the number of transmission attempts exceeds a transmission attempts threshold, transmit a legacy preamble indicated by the RACH configuration information.

26. The terminal device of claim 21, wherein the at least one memory storing instructions that, when executed by the at least one processor, cause the terminal device further to:
determine a synchronization signal block (SSB) associated with a measurement result;
determine, from at least one random access occasion (RO) of the PRACH preamble, a RO associated with the SSB based on the RACH configuration information; and
transmit the PRACH preamble in the RO.

27. The terminal device of claim 26, wherein the RACH configuration information further indicates a mapping between the at least one RO and at least one SSB.

28. The terminal device of claim 26, wherein a first number of the at least one SSB is less than or equal to a second number of the at least one RO.

29. The terminal device of claim 21, wherein the terminal device is at least one of: a mixed PRACH capable terminal, or a flexible duplexing (FDU)-aware terminal.

30. An apparatus comprising:
means for receiving, at a terminal device from a network device, random access channel (RACH) configuration information indicating at least two physical random access channel (PRACH) configuration indexes;
means for selecting one PRACH configuration index from the at least two PRACH configuration indexes; and
means for transmitting, to the network device, a RACH preamble based on the selected PRACH configuration index.

31. The apparatus of claim 30, further comprising:
means for receiving the RACH configuration information via a radio resource control (RRC) message, wherein the RACH configuration information indicates the at least two PRACH configuration indexes and at least one of:
a reference signal receiving power (RSRP) threshold,
a reference signal receiving quality (RSRQ) threshold,
a path loss threshold,
a signal to interference plus noise ratio (SINR) threshold, or
a transmission attempts threshold.

32. The apparatus of claim 30, wherein the at least two RACH configuration indexes comprise a first RACH configuration index associated with a first PRACH preamble and a second RACH configuration index associated with a second PRACH preamble, and wherein the at least one memory storing instructions that, when executed by the at least one processor, cause the terminal device to select one PRACH configuration index by:
selecting a longer one of the first PRACH preamble or the second PRACH preamble based on determining that a measurement result indicates at least one of:
a measured RSRP is below an RSRP threshold,
a measured path loss exceeds a path loss threshold, or
a measured SINR is below an SINR threshold.

33. The apparatus of claim 30, wherein the at least two RACH configuration indexes comprise a first RACH configuration index associated with a first PRACH preamble and a second RACH configuration index associated with a second PRACH preamble, and wherein the at least one memory storing instructions that, when executed by the at least one processor, cause the terminal device to select one PRACH configuration index by:
selecting a shorter one of the first PRACH preamble or the second PRACH preamble based on determining that a measurement result indicates at least one of:
a measured RSRP exceeds an RSRP threshold,
a measured path loss is below a path loss threshold, or
a measured SINR exceeds an SINR threshold.

34. The apparatus of claim 30, further comprising:
means for determining a number of transmission attempts of the PRACH preamble;
means for determining that the number of transmission attempts exceeds a transmission attempts threshold; and
based on determining that the number of transmission attempts exceeds a transmission attempts threshold, means for transmitting a legacy preamble indicated by the RACH configuration information.

35. The apparatus of claim 30, further comprising:
means for determining a synchronization signal block (SSB) associated with a measurement result;
means for determining, from at least one random access occasion (RO) of the PRACH preamble, a RO associated with the SSB based on the RACH configuration information; and
means for transmitting the PRACH preamble in the RO.

36. The apparatus of claim 35, wherein the RACH configuration information further indicates a mapping between the at least one RO and at least one SSB.

37. The apparatus of claim 35, wherein a first number of the at least one SSB is less than or equal to a second number of the at least one RO.

38. The apparatus of claim 30, wherein the terminal device is at least one of: a mixed PRACH capable terminal, or a flexible duplexing (FDU)-aware terminal.

39. A computer readable medium comprising program instructions stored on a non-transitory storage device which when executed by a processor of an apparatus, cause the apparatus at least to:
receive, at a terminal device from a network device, random access channel (RACH) configuration information indicating at least two physical random access channel (PRACH) configuration indexes;
select one PRACH configuration index from the at least two PRACH configuration indexes; and
transmit, to the network device, a RACH preamble based on the selected PRACH configuration index.
